(19) United States
(12) Patent Application Publication
(10) Pub. No.: US 2009/0319146 A1
(43) Pub. Date: Dec. 24, 2009

(54) TRACTION CONTROL SYSTEM FOR DIESEL POWERED VEHICLES

(76) Inventor: Toby E. Graham, Sterling, CO (US)

Correspondence Address: Mitchell, Kristi & Lieber, P.C., 1220 Washington Street, 3rd Floor, Kansas City, KS, 64105-2245, US

(21) Appl. No.: 12/489,202

(22) Filed: Jun. 22, 2009

Related U.S. Application Data
(60) Provisional application No. 61/074,267, filed on Jun. 20, 2008.

(51) Int. Cl. B60T 7/12

(52) U.S. Cl. 701/86

(57) ABSTRACT

The present invention provides an improved traction control system which can be advantageously applied to a vehicle which does not employ a spark ignition engine, such as a vehicle powered by a diesel engine. In an embodiment of the invention, a traction control unit (TCU) and a digital potentiometer are interfaced between the wheel speed sensors and the vehicle ECU. The traction control unit senses wheel, the traction control unit causes the digital potentiometer to decrement the throttle position sensor voltage read by the ECU, which in turn reduces the fuel flow through the fuel injector. The reduction in fuel flow reduces the wheel speed and/or wheel torque thereby allowing the slipping wheels to regain traction. When traction is regained, the traction control unit causes the digital potentiometer to begin incrementing the throttle position sensor voltage back up to its standard voltage, determined by the current throttle position, thereby causing the ECU to increase the fuel flow through the fuel injector to the standard level for the current throttle position.

### CLAIM OF PRIORITY

This application claims priority of U.S. Provisional Application No. 61/074,267, entitled: Traction Control System for Diesel Powered Vehicles, inventor: Toby Graham, and filed on Jun. 20, 2008.

### BACKGROUND OF THE INVENTION

The present invention is generally directed to automotive engine control equipment and, more particularly, to a traction control system for vehicles propelled by diesel engines.

Automotive vehicles achieve locomotion by rotating drive wheels having tires frictionally engaging pavement or the ground. If the friction between the tires of any of the drive wheels and the pavement is overcome, wheel slip occurs. Wheel slip is undesirable in most situations and can be hazardous if it causes the vehicle to move in an uncontrolled manner.

Traction control systems have been devised to automatically reduce wheel slip to enable a driver to regain traction. Conventional traction control systems typically operate by obtaining a wheel slip value, comparing the slip value to a particular threshold, and reducing the propulsive power of the vehicle engine as long as the slip value exceeds the threshold. The propulsive power is often reduced by retarding spark ignition timing, up-shifting the transmission, and possibly applying brake pressure to the spinning wheel. A wheel slip value can be derived from sensing differential rotational rates of drive wheels, the rate and extent of drive shaft speed increases, or the like.

Conventional traction control systems are not directly applicable to diesel engine powered vehicles because diesel engines employ compression ignition of a fuel mixture instead of spark ignition. Thus, control of spark ignition to achieve traction control is not possible with diesel powered vehicles. However, diesel engines are used for propulsion of a wide range of vehicles, from small passenger cars to large trucks. Thus, there is a need for a traction control system which can be effectively applied to diesel powered vehicles.

### SUMMARY OF THE INVENTION

The present invention provides an improved traction control system which can be advantageously applied to a vehicle which does not employ a spark ignition engine, such as a vehicle powered by a diesel engine. Propulsion components of the vehicle are electronically monitored to determine when traction is lost. The degree of loss of traction is determined as a slip value. The slip value is compared to a preset slip threshold. If the slip value exceeds the slip threshold, a traction controller causes fuel flow to the fuel injector to be reduced in increments until the slip value no longer exceeds the slip threshold, indicating that traction has been regained. At that point, fuel flow to the fuel injector is increased in increments until a normal fuel flow has been reached.

Modern vehicles are provided with an electronic control unit (ECU) which typically controls ignition timing, for a spark ignition engine, and a fuel injector, based on input from a throttle position sensor (TPS) and other inputs. Vehicles with automatic braking systems (ABS) have a wheel speed sensor on each wheel interfaced to an ABS controller or to the ECU to automatically modify brake application to avoid wheel lock-up when brakes are applied strongly. In an embodiment of the invention, a traction control unit (TCU) and a digital potentiometer are interfaced between the wheel speed sensors and the vehicle ECU. The throttle position sensor is also interfaced to the digital potentiometer.

The traction control unit monitors the wheel speed sensors to determine if the faster of the driving wheels, such as the faster front wheel of a front-wheel driven vehicle, is rotating faster than the fastest of the non-driven wheels, such as the rear wheels. If a difference is detected, a wheel slip value is derived from the difference and compared to a preset slip threshold. If the slip value exceeds the threshold, the traction control unit causes the digital potentiometer to decrement the throttle position sensor voltage read by the ECU, which in turn reduces the fuel flow through the fuel injector. The apparent reduction in throttle position sensor voltage makes it appear to the ECU that the driver has backed off on the throttle, and the ECU responds by reducing the fuel flow through the fuel injector. The reduction in fuel flow reduces the wheel speed and/or wheel torque thereby allowing the slipping wheels to regain traction. When traction is regained, the slip value drops below the threshold. In response, the traction control unit causes the digital potentiometer to begin incrementing the throttle position sensor voltage back up to its standard voltage, determined by the current throttle position, thereby causing the ECU to increase the fuel flow through the fuel injector to the standard level for the current throttle position.

While the traction control system of the present invention is particularly intended for use with diesel engines, it is may also be applicable to some types of vehicle with spark ignition engines.

Objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a block diagram illustrating principal components of a traction control system according to the present invention.

FIG. 2 is a flow diagram illustrating principal steps in a traction control process according to the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings, the reference numeral 1 generally designates components of an embodiment of the traction control system of the present invention. The traction control system 1 generally monitors selected magnitudes and kinds of differential wheel speed to determine a slip value, compares the slip value to a preset threshold, and decreases fuel flow to the vehicle engine until the slip value decreases below the threshold, thereby determining that traction has been regained.

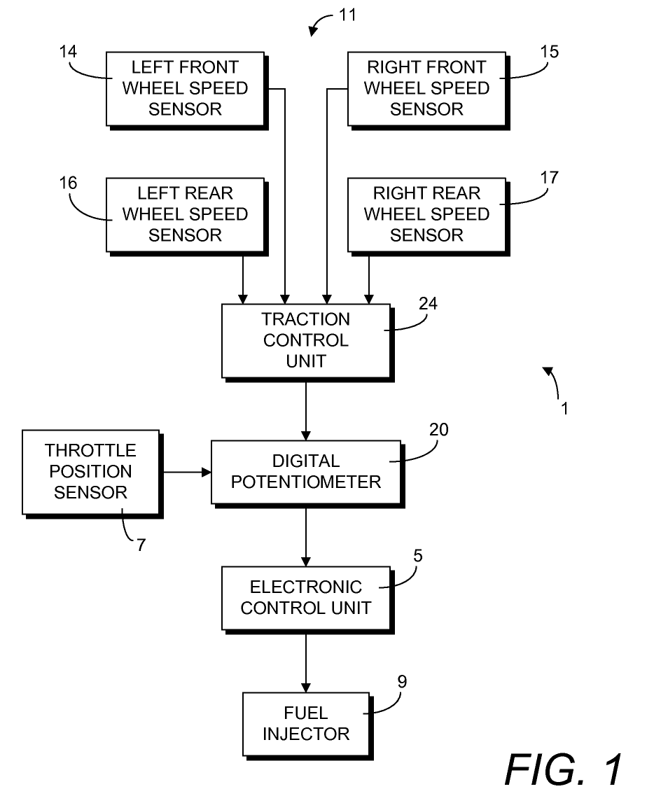

Referring to FIG. 1, a typical modern vehicle has an electronic control unit (ECU) 5 which receives an input, such as a voltage, from a throttle position sensor (TPS) 7 which is calibrated to a position of a throttle control or vehicle accelerator (not shown). The ECU 5 uses the TPS input voltage to control the vehicle engine, according to a stored program or programs within the ECU 5. In a spark ignition engine, control is exerted over spark ignition timing along with fuel flow through a fuel injector 9. With a compression ignition, or diesel, engine, spark ignition timing is not present, such that throttle position controls only fuel flow through the fuel injector 9.

Modern vehicles are often provided with an automatic braking system (ABS) which provides more controlled braking by sensing and preventing wheel lock-up when brakes are applied strongly. Automatic braking systems employ individual wheel speed sensors 11 which monitor wheel speeds and input signals indicating wheel speed to an ABS controller (not shown) or, alternatively, to ABS inputs of an electronic control unit 5. The ABS controller temporarily or repeatedly releases the brake on a wheel which is sensed to not be turning to maintain traction and stable tracking of a vehicle when the brakes are suddenly applied. The illustrated wheel speed sensors 11 include left and right front wheel speed sensors 14 and 15 and left and right rear wheel speed sensors 16 and 17. The wheel speed sensors 11 may be Hall Effect devices which detect the passage of magnets on rotating wheel shafts in proximity thereto. Alternatively, it is foreseen that the sensors 11 could be of various optical configurations.

An embodiment of the traction control system 1 interfaces a digital potentiometer 20 between the throttle position sensor 7 and the electronic control unit 5, along with a traction control unit 24 between the wheel speed sensors 11 and the digital potentiometer 20. A digital potentiometer 20 is a digital circuit which emulates the function of an analog potentiometer to adjust and trim an electronic circuit in a manner similar to a resistor, rheostat, or mechanical potentiometer. Various digital potentiometer circuits are available from Analog Devices (www.analog.com) and other vendors. In the traction control system 1, the digital potentiometer 20 functions, under control of the traction control unit 24, to modify the voltage reading the ECU 5 receives from the throttle position sensor 7 when the traction control unit 24 senses that traction has been lost. The traction control unit 24, in a manner similar to the electronic control unit 5, is a microprocessor or microcontroller with input/output (I/O) ports and a stored operating program or programs.

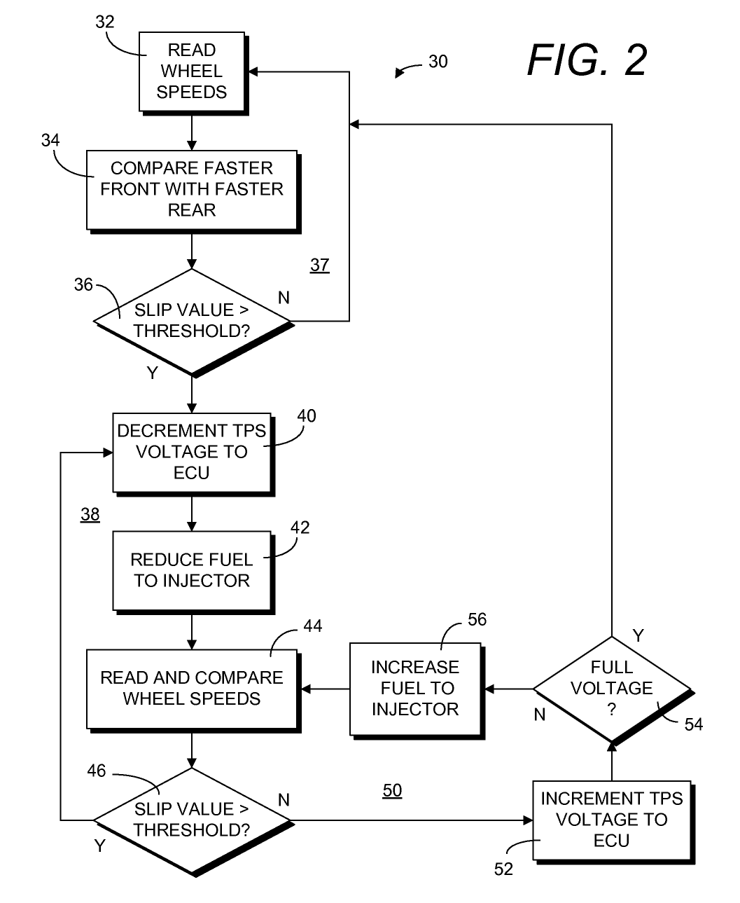

FIG. 2 illustrates an exemplary traction control process 30 by which the traction control system 1 can operate. At step 32, the wheel speed sensors 11 are read by the traction control unit 24 and compared in step 34. When acceleration traction is lost, one or both of the driven wheels turn faster than the non-driven wheels. Also, there is a difference in rotation rates of left and right side wheels during turns and curves, with wheels on the outer side of the turn or curve turning faster. In the illustrated step 34, the faster of front speed sensors 14 and 15 is compared with the faster of the rear speed sensors 16 and 17 to obtain a slip value, which may be equal or proportional to the difference in wheel speed rotation rates. At step 36, the slip value obtained is compared to a preset slip threshold. If the slip value does not exceed the slip threshold, the process 30 loops back to the read step 32 in a normal loop 37 that continues as long as the slip value does not exceed the slip threshold at step 36.

If the slip value exceeds the slip threshold, the process 30 enters a fuel flow reduction or decrement loop 38 in which fuel flow is gradually reduced to cause traction to be regained. The loop 38 begins by the throttle position sensor voltage being decremented at step 40 by way of the digital potentiometer 20. This causes the ECU 5 to reduce the fuel flow through the fuel injector 9 at step 42. At step 44, the wheel speeds are read and compared, as in the steps 32 and 34, to determine a new slip value. At step 46, the new slip value is compared to the preset slip threshold. If the new slip value still exceeds the slip threshold, the process 38 loops back to the decrement step 40, and the throttle position sensor voltage is decremented further. At some point, either through the function of the traction control process 30 or the driver letting up on the accelerator, traction will be regained. At that point, the measured slip value will no longer exceed the slip threshold. When that is determined at step 46, the process 30 exits the decrement loop 38 and enters a fuel flow restoration or increment loop 50.

At step 52, the traction control unit 24 increments the throttle position sensor voltage read by the ECU 5, by way of the digital potentiometer 20. At step 54, a test is run to determine if the full voltage from the TPS 7, as determined by its position, is being applied to the ECU 5. This may be done by determining if the digital potentiometer 20 is adding any resistance between the TPS 7 and its terminal on the ECU 5. If the full voltage of the TPS 7 is not being applied to the ECU 5, the ECU 5 increases the fuel flow through the fuel injector 9 in response to step 52. Thereafter, the process 30 loops back through the wheel speed read and compare step 44 and the slip value comparison step 46. The process 30 continues in the increment loop 50 until the full voltage of the TPS 7 is reached at step 54. At that point, the process 30 exits the increment loop 50, and control is returned to the normal loop 37.

While the traction control system 1 has been described as employing a digital potentiometer 20 to vary a voltage from the throttle position sensor 7 which is read by the ECU 5, it is foreseen that other configurations of a throttle position sensor could also be employed in a vehicle, such as a digital throttle position sensor. The system 1 and process 30 are intended to be adaptable to vary a throttle position signal from such a digital throttle position sensor to cause the electronic control unit to control fuel flow through a fuel injector in such a manner as to thereby control and maintain traction in a vehicle employing such a digital throttle position sensor.

It is to be understood that while certain forms of the present invention have been illustrated and described herein, it is not to be limited to the specific forms or arrangement of parts described and shown.

What is claimed and desired to be secured by Letters Patent is:

1. A traction control process for a vehicle having wheels and an engine with a fuel injector, said process comprising the steps of:
(a) sensing a slip value corresponding to slippage of at least one of said wheels;
(b) comparing said slip value to a selected slip threshold;
(c) upon said slip value exceeding said slip threshold, decreasing fuel flow through said fuel injector to thereby decrease said slip value below said slip threshold.

2. A process as set forth in claim 1 wherein said sensing step includes the steps of:
(a) sensing a rotational speed of each of said wheels;
(b) comparing a rotational speed of a selected one of said wheels to a rotational speed of a selected other of said wheels to determine a differential rotational speed; and
(c) converting said differential rotational speed to said slip value.

3. A process as set forth in claim 1 wherein said vehicle includes front wheels and rear wheels and said sensing step includes the steps of:
(a) sensing a rotational speed of each of said wheels;
(b) comparing a rotational speed of a faster front wheel to a rotational speed of a faster rear wheel to determine a differential rotational speed; and
(c) converting said differential rotational speed to said slip value.

4. A process as set forth in claim 1 and including the step of:
(a) upon said slip value no longer exceeding said slip threshold, returning fuel flow through said fuel injector to a normal level to thereby enable full usage of said engine.

5. A process as set forth in claim 1 wherein:
(a) said engine is a diesel engine.

6. A process as set forth in claim 1 wherein said engine includes a throttle position sensor and an electronic control unit controlling said fuel injector and wherein said decreasing said fuel flow step includes the step of:
(a) decrementing a throttle position sensor voltage and thereby causing said electronic control unit to reduce fuel flow to said fuel injector until said slip value no longer exceeds said slip threshold.

7. A process as set forth in claim 6 and including the step of:
(a) upon said slip value no longer exceeding said slip threshold, incrementing said throttle position sensor voltage and thereby causing said electronic unit to increase fuel flow to said fuel injector until a non-reduced throttle position sensor voltage has been reached.

8. A process as set forth in claim 6 and including the step of:
(a) sensing digital throttle position sensor value; and
(b) converting said digital throttle position sensor value into a throttle position sensor voltage.

9. A traction control process for a vehicle having wheels and a diesel engine with a fuel injector, a throttle position sensor, and an electronic control unit controlling said fuel injector, said process comprising the steps of:
(a) sensing rotational speeds of said wheels;
(b) comparing a rotational speed of a faster front wheel with a rotational speed of a faster rear wheel to determine a slip value;
(c) comparing said slip value with a selected slip threshold;
(d) upon said slip value exceeding said slip threshold, decrementing a throttle position sensor voltage and thereby causing said electronic control unit to reduce fuel flow to said fuel injector until said slip value no longer exceeds said slip threshold; and
(e) upon said slip value no longer exceeding said slip threshold, incrementing said throttle position sensor voltage and thereby causing said electronic unit to increase fuel flow to said fuel injector until a non-reduced throttle position sensor voltage has been reached.

10. A process as set forth in claim 9 and including the step of:
(a) sensing digital throttle position sensor value; and
(b) converting said digital throttle position sensor value into a throttle position sensor voltage.

11. A traction control system for a vehicle having wheels and an electronic control unit controlling fuel flow through a fuel injector in response to a throttle position signal sensed from a throttle position sensor, said system comprising:
(a) a respective wheel speed sensor on each of selected wheels of the vehicle;
(b) a traction control unit having the wheel speed sensors couple thereto and receiving respective wheel speed signals therefrom;
(c) a digital potentiometer having said throttle position sensor and said traction control unit coupled thereto and being coupled to said electronic control unit; and
(d) said traction control unit causing said digital potentiometer to vary said throttle position signal in response to selected speed signals from said speed sensors to thereby cause said electronic control unit to control fuel flow to said fuel injector in such a manner as to maintain traction of said wheels.
